(19) United States
(12) Patent Application Publication
(10) Pub. No.: US 2024/0009709 A1
(43) Pub. Date: Jan. 11, 2024

(54) MULTI-CYCLE SHIPMENT SORTING SYSTEM AND CONTROL METHOD THEREFOR

(71) Applicant: Zhejiang Libiao Robots Co., Ltd., Zhejiang (CN)

(72) Inventor: Jianqiang ZHU, Zhejiang (CN)

(21) Appl. No.: 18/037,445

(22) PCT Filed: Nov. 22, 2021
(86) PCT No.: PCT/CN2021/131985

§ 371 Date: May 17, 2023

(30) Foreign Application Priority Data
Feb. 21, 2021 (CN) 202110194578.5

(51) Int. Cl. B07C 3/06; B66F 9/06; B65G 63/00; G06Q 10/083

(52) U.S. Cl. CPC B07C 3/06; B66F 9/063; B65G 63/002; G06Q 10/083; B07C 2301/0016

(57) ABSTRACT

A multi-cycle shipment sorting system and a control method thereof. The system comprises: a delivery platform; a delivery device, capable of delivering a plurality of shipment boxes from a delivery entrance to an unloading port, and after unloading, outputting the shipment boxes from a delivery exit, each shipment box having a recognition device mounted thereon; a sorting platform, provided with a sorting entrance, a sorting exit, and a cyclic section, the cyclic section being provided with a loading port; self-navigation trolleys, multiple trolleys being provided, and the trolleys traveling into the platform from the sorting entrance, being ordered by the positions of shipments delivered by the delivery device when passing through the cyclic section, and after loading at the loading port, traveling out of the platform from the sorting exit; a positioning device, used for performing positioning the self-navigation trolleys; and a shipment handling device.

### CROSS-REFERENCE TO RELEVANT APPLICATIONS

The present disclosure claims the priority of the Chinese patent application filed with the China National Intellectual Property Administration on Feb. 21, 2021 with the application number of 202110194578.5, entitled of “MULTY-CYCLE SHIPMENT SORTING SYSTEM AND CONTROL METHOD THEREOF”, which is incorporated herein in its entirety by reference.

### TECHNICAL FIELD

The present disclosure relates to a shipment sorting system.

### BACKGROUND ART

Sorting shipments by self-navigation trolleys, i.e., robots, has been widely used in some situations.

For example, online retailers have a lot of commodities sold on the Internet, and in the process of online shopping, users will choose different commodities to place orders. When the retailers receive orders, they need to select these commodities from their warehouses one by one, package them uniformly, and deliver them to the users. If the distribution of shipments is completely manual, the cost will be increased significantly, and the selection of all-machine sorting or the combination of manual and machine can meet various requirements.

### SUMMARY

The present disclosure provides a multi-cycle shipment sorting system and a control method thereof.

In some embodiment, the multi-cycle shipment sorting system may include:
a delivery platform, wherein the delivery platform is provided with a delivery entrance, a delivery exit, and an unloading port;
a delivery device, wherein the delivery device are capable of delivering a plurality of shipment boxes sequentially from the delivery entrance to the unloading port, and after unloading, out putting the shipment boxes from the delivery outlet, wherein more than one piece of the same kind of shipment is contained in each of the shipment boxes, different shipment boxes are capable of containing the same or different shipments, and each of the shipment boxes is installed with an identification device;
a sorting platform, wherein the sorting platform is provided with a sorting entrance, a sorting outlet, and a cyclic section, wherein the cyclic section is provided with a loading port;
plural self-navigation trolleys, wherein the self-navigation trolleys, when enter from the sorting entrance and pass through the cyclic section, are ranked according to positions of the shipments delivered by the delivery device, and then run out of the sorting exit after being loaded at the loading port;
plural self-navigation trolleys, wherein the self-navigation trolleys enter from the sorting entrance, pass through the cyclic section, and run out of the sorting outlet after being loaded at the loading port;
a positioning device, wherein the positioning device is configured for performing positioning when the self-navigation trolleys are running;
a shipment-carrying device, wherein the shipment-carrying device is provided with an identifier that is capable of reading identification devices of the shipment boxes, the identifier is fixed close to the unloading port, and a man or a robot can take the shipments out of the shipment boxes and load them on the self-navigation trolleys located at the loading port; and
a server, wherein the server is connected to the self-navigation trolleys in a wireless manner, and is connected to the identifier, the delivery device, and the robot in a wired or wireless manner, respectively.

Optionally, the self-navigation trolleys are capable of running in multiple cycles on the cyclic section.

Optionally, the cycle can be a clockwise or counterclockwise single-direction cycle.

Optionally, the self-navigation trolleys are capable of passing through the loading port several times to be loaded.

Optionally, the identification device can be a bar code, a QR code, a graphic mark, a color mark, a size mark, or an RFID tag, and correspondingly, the identifier is a camera or an RFID card reader.

Optionally, the shipment-carrying device may further include:
a displayer and/or a sound player, wherein the displayer and/or the sound player are electrically connected to the server, and the shipments are loaded manually according to prompts of the displayer and/or the sound player.

Optionally, the delivery device can be a drum conveyor, the shipment boxes are placed on the drum conveyor to be conveyed, and the drum conveyor is electrically connected to the server.

Optionally, the drum conveyor is U-shaped.

Optionally, the delivery device can be the self-navigation trolleys, the self-navigation trolleys are connected to the server in a wireless manner, and the positioning device for running of the self-navigation trolleys is installed on the delivery platform.

Optionally, the delivery entrance and the delivery outlet are connected to warehouse, and the delivery device is connected to the warehouse that delivers the shipments; the server can obtain information of the shipments through scanning QR codes of the shipments by a code scanner, and obtain information of the shipment boxes through the identification devices of the identifier; and
the sorting entrance and the sorting outlet can be connected to a packaging place.

Optionally, a plurality of bar codes, QR codes, graphic marks, color marks, size marks, or RIFD tags can be selected for the positioning device to be pasted on the platform, and cameras are installed on the self-navigation trolleys.

A control method for a multi-cycle shipment sorting system, which may include the following steps:
S1, unloading shipments by a plurality of shipment boxes when the shipments pass through an unloading port from a delivery entrance, wherein the shipment boxes are outputted via a delivery outlet;
S2, performing ranking, when a plurality of self-navigation trolleys enter from a sorting entrance and pass through a cyclic section, according to positions of shipments delivered by delivery device, wherein the self-navigation trolleys run out of a sorting outlet after loading the shipments at a loading port;
S3, carrying the shipments in the shipment boxes that pass through the unloading port manually or by a robot to the self-navigation trolleys that pass through the loading port;
S4, the self-navigation trolley running out of the sorting outlet and completing the sorting, without running in cycles again on the cyclic section, if the owner of the shipments on the same self-navigation trolley only owns those shipments; and
S5, the self-navigation trolley waiting to continue loading at the loading port, or, running to the cyclic section to wait to be loaded, if the owner of the shipments on the same self-navigation trolley owns other shipments, wherein when said other shipments are conveyed to the unloading port, the self-navigation trolley runs to the loading port to be loaded again, and so on; finally, the self-navigation trolley runs out of the sorting outlet and completes the sorting.

The present disclosure has at least the following advantages:

The delivery platform and the delivery device may adopt drum conveyor to convey the shipments. Compared with the self-navigation trolleys, the drum conveyor has low cost and large shipment load. Even if self-navigation trolleys are adopted, they may be arranged in a line, and although the cost is slightly higher, the shipment load is also very large.

The shipment-carrying device may be used by a human or robot. When the shipment-carrying device is used by a human, as the action thereof is a single repeated action that is not easy to make mistakes, the efficiency is very high, and the cost is relatively low. When carrying a plurality of shipments in the same shipment box, the efficiency is even significantly higher than a robot;

The self-navigation trolleys are very flexible in the running process. For the self-navigation trolleys that only carry only one shipment, they run out directly after passing through the cyclic section, thus making the road unblocked. For the self-navigation trolleys that need to carry a plurality of shipments, they enter the cyclic section to queue up and wait, and the waiting may be mobile; therefore, it is very flexible, and the waiting time for the self-navigation trolleys may be relatively short, resulting in a very high loading efficiency.

The present disclosure at least has the beneficial effects of a reasonable structure, a low cost, a small sorting site, a convenient distribution of shipments, and a high sorting efficiency.

### BRIEF DESCRIPTION OF DRAWINGS

FIG. 1 is a schematic diagram of the overall structure of the present disclosure;

FIG. 2 shows embodiment 1 of ranking of loading of the present disclosure; and

FIG. 3 shows embodiment 2 of ranking of loading of the present disclosure.

### DETAILED DESCRIPTION OF EMBODIMENTS

The present disclosure is further explained in conjunction with the accompanying drawings:

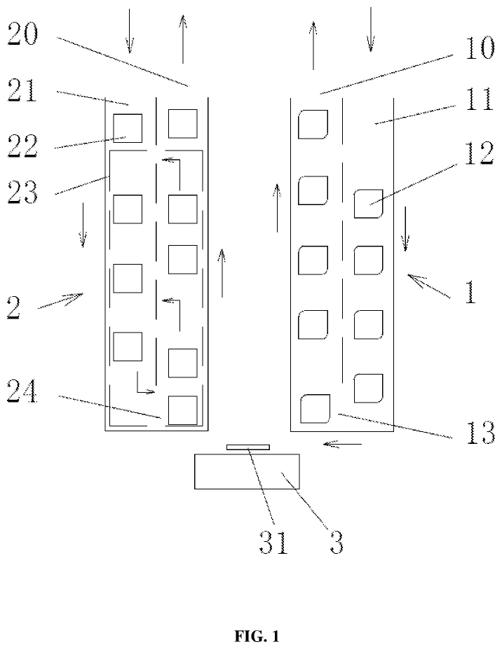

As shown in FIG. 1, a multi-cycle shipment sorting system includes:
a delivery platform 1, which is provided with a delivery 11, a delivery outlet 10, and an unloading port 13;
delivery device, which is capable of delivering a plurality of shipment boxes 12 in sequence from the delivery entrance 11 to the unloading port 13, and outputting, after unloading, the shipment boxes 12 from the delivery outlet 10, wherein more than one piece of the same kind of shipment is contained in each of the shipment boxes 12, different shipment boxes 12 are capable of containing same or different shipments, and each of the shipment boxes 12 is installed with an identification device;
a sorting platform 2, which is provided with a sorting entrance 21, a sorting outlet 20, and a cyclic section 23, wherein the cyclic section 23 is provided with a loading port 24;
plural self-navigation trolleys 22, wherein the self-navigation trolleys 22 enter from the sorting entrance 21, then are ranked, when passing through the cyclic section 23, according to the positions of shipments delivered by the delivery device, and run out of the sorting outlet 20 after loading at the loading port 24;
a positioning device, which is configured for performing positioning when the self-navigation trolleys 22 are running;
a shipmen-carrying device, which is provided with an identifier that is capable of reading the identification devices of the shipment boxes, wherein the identifier is fixed close to the unloading port 13, and the shipments in the shipment boxes 12 can be taken out and loaded on the self-navigation trolleys 22 located at the loading port 24 manually or by a robot 3; and
a server, which is connected to the self-navigation trolleys 22 in a wireless manner, and is connected to the identifier, the delivery device, and the robot in a wired or wireless manner, respectively.

The delivery platform 1 and the sorting platform 2 of the present disclosure may be arranged in parallel or at an angle, and they may also be arranged in a line. The installation is flexible, the site utilization rate is very high, and the carry may be performed manually or by the robot 3.

It should be noted that, loading of shipments into the shipment boxes 12 are completed before entering the delivery entrance 11. Generally, the information of shipments are obtained by the server through scanning QR codes of the shipments via a QR code scanner, and the information of the shipment boxes 12 are obtained through identifying the identification devices of the shipment boxes 12 via the identifier, so as to facilitate the server to arrange schedules in advance.

It should be also noted that, the delivery platform 1 and the delivery device mainly complete picking up and unloading shipments from a warehouse, while the ranking of shipment boxes 12 is basically fixed. The sorting platform 2 and the self-navigation trolleys 22 mainly complete sorting, loading, and unloading at terminals, the ranking of self-navigation trolleys 22 is set according to the positions of shipments. The two routes do not interfere with each other, so that the sorting effect may be significantly improved when the sorting site is small.

Optionally, for the self-navigation trolleys 22 which need to be loaded again, they are capable of running in multiple cycles on the cyclic section 23.

It should be noted that running in cycles may be running in cycles for a short path or a long path. Through calculation by software of the server, the arrangement is flexible, and even if the shipments are not loaded for the time being, in order to give ways to other self-navigation trolleys 22, they may also run for one more cycle, and the cycle is mainly in one direction such as clockwise or counterclockwise.

It should also be noted that, the sorting platform 2 of the present disclosure is only capable of accommodating two rows of the self-navigation trolleys 22 to run.

The sorting entrance 21 is located in one of the two rows, and the sorting outlet 20 is located in the other row, and at this time, the platform occupies the smallest land area and has the highest utilization rate.

When the same owner has a plurality of different shipments, the self-navigation trolleys 22 are capable of passing through the loading part 24 and loading for multiple times.

Optionally, the identification device of the shipment box is a bar code, a QR code, a graphic mark, a color mark, a size mark, or an RFID tag, and correspondingly, the identifier is a camera or an RFID card reader.

Optionally, the shipment-carrying device further includes:
a displayer 31 and/or a sound player, wherein the displayer 31 and/or the sound player are electrically connected to the server, and workers load the shipments manually according to the prompts of the displayer and/or the sound player. When a plurality of the same shipments are loaded on the same self-navigation trolley 22, the efficiency of manual labor is higher than the loading efficiency of the robot 3.

It should be noted that, it is possible that the shipments contained in a shipment box 12 belong to two owners, and at this time, it is prompted by the displayer 31 and/or the sound player that how many pieces are installed, and the remaining shipments will be loaded by the next self-navigation trolley 22.

Preferably, the delivery device is a drum conveyor, wherein the shipment boxes 12 are placed on the drum conveyor to be conveyed, and the drum conveyor is electrically connected to the server. The drum conveyor may adopt existing products, which have the characteristics of a relatively low cost and a large shipment load.

Preferably, the drum conveyor is U-shaped. The U-shaped refers to the route of conveying, and the U-shaped drum conveyor can save the site.

As another embodiment, the delivery device are the self-navigation trolleys, the self-navigation trolleys are connected to the server in a wireless manner, and a positioning device for running of the self-navigation trolleys 22 is installed on the delivery platform 1.

When the delivery device adopts the self-navigation trolleys, the self-navigation trolleys are relatively flexible during the loading of the shipments.

Optionally, the delivery entrance 11 and the delivery outlet 10 are connected to a warehouse, and the delivery device is connected to the warehouse that delivers the shipments; information of the shipments are obtained by the server through scanning OR codes of the shipments via the code scanner, and information of the shipment boxes 12 are obtained through identifying the identification devices of the shipment boxes 12 via the identifier; and
the sorting entrance 21 and the sorting outlet 20 are connected to a packaging place, and the self-navigation trolleys 22 may perform sorting in cycles.

The technical solution consists of a complete system from delivering, sorting to packaging.

The positioning device for the running of self-navigation trolleys 32 is relevant technology. The positioning device may adopt a plurality of bar codes, QR codes, graphic marks, size marks, or RFID tags to be pasted on the platform. Correspondingly, cameras are installed on the self-navigation trolleys 22.

A control method for a multi-cycle shipment sorting system includes the following steps:
S1, unloading shipments by a plurality of shipment boxes 12 when the shipments pass through an unloading port 13 from a delivery entrance 11, wherein the shipment boxes 12 are outputted via a delivery outlet 10;
S2, performing ranking, when a plurality of self-navigation trolleys enter from a sorting entrance and pass through a cyclic section, according to positions of shipments delivered by delivery device, wherein the self-navigation trolleys exit a sorting outlet after loading the shipments at a loading port;
S3, carrying the shipments in the shipment boxes 12 that pass through the unloading port 13 manually or by a robot 3 to the self-navigation trolleys 22 that pass through the loading port 24;
S4, the self-navigation trolley 22 running out of the sorting outlet 20 and completing the sorting, without running in cycles again on the cyclic section 23, if the owner of the shipments on the same self-navigation trolley 22 only owns those shipments; and
S5, the self-navigation trolley 22 waiting to continue loading at the loading port 24, or, running to the cyclic section 23 to wait to be loaded, if the owner of the shipments on the same self-navigation trolley 22 owns other shipments, wherein when said other shipments are conveyed to the unloading port 13, the self-navigation trolley 22 runs to the loading port 24 to be loaded again, and so on; finally, the self-navigation trolley 22 runs out of the sorting outlet 20 and completes the sorting.

Steps S4 and S5 are several specific methods of ranking, and specific embodiments of ranking are introduced here:

When there is only one shipment in a shipment box, and its owner only has that shipment, any self-navigation trolley may be arranged, generally, a self-navigation trolley that stays at the loading port is arranged for loading.

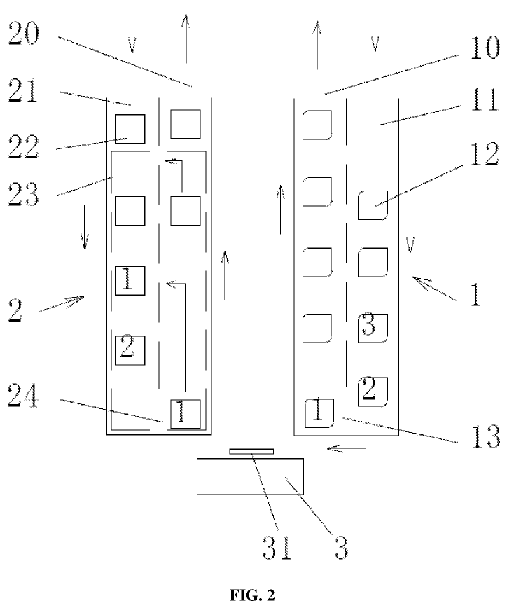

When the same owner needs two pieces of different shipments, as shown in FIG. 2, for example, the first shipment is in No. 1 shipment box and the second shipment is in No. 3 shipment box, at this time, the No. 1 self-navigation trolley immediately queued up, after completing loading of the shipment, behind the No. 2 self-navigation trolley through the cyclic section. After the shipment in the No. 2 shipment box is loaded on the No. 2 self-navigation trolley, the shipment in the No. 3 shipment box is loaded on the No. 1 self-navigation trolley, and so on.

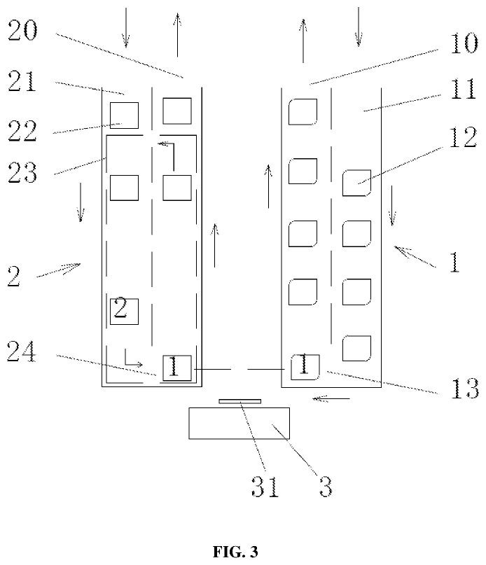

When two pieces of shipment from different owners are installed in the same shipment box, as shown in FIG. 3, for example, the No. 1 shipment box contains two pieces of the same shipment, at this time, after the first piece of shipment in the No. 1 shipment box is loaded on the No. 1 self-navigation trolley, the No. 2 self-navigation trolley queued up in advance behind the No. 1 self-navigation trolley, and then loads the second piece of the shipment on the No. 2 self-navigation trolley, and so on.

### INDUSTRIAL APPLICABILITY

The present disclosure provides a multi-cycle shipment sorting system and a control method thereof, wherein the system includes: a delivery platform; delivery device, which is capable of delivering a plurality of shipment boxes from the delivery entrance to the unloading port, and out putting, after unloading, the shipment boxes from the delivery outlet, wherein each of the shipment boxes is installed with an identification device; a sorting platform, which is provided with a sorting entrance, a sorting outlet and a cyclic section, wherein the cyclic section is provided with a loading port; plural self-navigation trolleys, which enter from the sorting entrance, and are ranked, when passing through the cyclic section, according to positions of shipments delivered by the delivery device, then run out of the sorting outlet after loading at the loading port; a positioning device, which is configured for performing positioning the self-navigation trolleys; a shipment-carrying device, which is provided with an identifier that is capable of reading identification devices of the shipment boxes, wherein the identifier is fixed close to the unloading port, and the shipments in the shipment boxes can be taken out and loaded on the self-navigation trolleys located at the loading port manually or by a robot. The present disclosure has the beneficial effects of a small sorting site, convenient distribution of shipments, and a high sorting efficiency.

In addition, it should be understood that, the multi-cycle shipment sorting system and the control method thereof provided by the present disclosure are reproducible, and can be applied in a variety of industrial applications. For example, the multi-cycle shipment sorting system and the control method thereof provided by the present disclosure may be applied to the field of application where the shipments are sorted by robots.

1. A multi-cycle shipment sorting system, comprising:
a delivery platform, provided with a delivery entrance, a delivery outlet, and an unloading port;
a delivery device, capable of delivering a plurality of shipment boxes in sequence from the delivery entrance to the unloading port, and outputting, after unloading, a plurality of the shipment boxes from the delivery outlet, wherein more than one piece of a same kind of shipment is contained in each of the shipment boxes, different shipment boxes are capable of containing same or different shipments, and each of the shipment boxes is installed with an identification device;
a sorting platform, provided with a sorting entrance, a sorting outlet, and a cyclic section, wherein the cyclic section is provided with a loading port;
plural self-navigation trolleys, wherein the self-navigation trolleys enter from the sorting entrance, and are ranked, when passing through the cyclic section, according to positions of shipments delivered by the delivery device, then run out of the sorting outlet after loading at the loading port;
a positioning device, configured for performing positioning when the self-navigation trolleys are running;
a shipment-carrying device, provided with an identifier that can read the identification devices of the shipment boxes, wherein the identifier is fixed close to the unloading port, and the shipments in the shipment boxes can be taken out and loaded on the self-navigation trolleys located at the loading port manually or by a robot; and
a server, wherein the server is connected to the self-navigation trolleys in a wireless manner, and is connected to the identifier, the delivery device, and the robot in a wired or wireless manner, respectively.

2. The multi-cycle shipment sorting system according to claim 1, wherein the self-navigation trolleys are capable of running in multiple cycles on the cyclic section.

3. The multi-cycle shipment sorting system according to claim 2, wherein the cycles are clockwise or counterclockwise single-direction cycles.

4. The multi-cycle shipment sorting system according to claim 2, wherein the self-navigation trolleys are capable of passing through the loading port several times to be loaded.

5. The multi-cycle shipment sorting system according to claim 1,
wherein the identification device is a bar code, a QR code, a graphic mark, a color mark, a size mark, or an RFID tag, and correspondingly, the identifier is a camera or an RFID card reader.

6. The multi-cycle shipment sorting system according to claim 1, wherein the shipment-carrying device further comprises:
a displayer and/or a sound player, wherein the displayer and/or the sound player is electrically connected to the server, and workers load the shipments manually according to prompts of the displayer and/or the sound player.

7. The multi-cycle shipment sorting system according to claim 1, wherein the delivery device is a drum conveyor, wherein the shipment boxes are placed on the drum conveyor to be conveyed, and the drum conveyor is electrically connected to the server.

8. The multi-cycle shipment sorting system according to claim 7, wherein, the drum conveyor is U-shaped.

9. The multi-cycle shipment sorting system according to claim 1, wherein the delivery device is the self-navigation trolleys, wherein the self-navigation trolleys are connected to the server in a wireless manner, and the positioning device for running of the self-navigation trolleys is installed on the delivery platform.

10. The multi-cycle shipment sorting system according to claim 4, wherein the delivery entrance and the delivery outlet are connected to a warehouse, and the delivery device is connected to a warehouse that delivers the shipments; information of the shipments is obtained by the server through scanning QR codes of the shipments via a code scanner, and information of the shipment boxes is obtained by the identifier through identifying the identification devices of the shipment boxes; and
the sorting entrance and the sorting outlet are connected to a packaging place.

11. The multi-cycle shipment sorting system according to claim 1, wherein a plurality of bar codes, QR codes, graphic marks, color marks, size marks, or RIFD tags are selected for the positioning device to be pasted on a platform, and cameras are installed on the self-navigation trolleys.

12. A control method for a multi-cycle shipment sorting system, comprising steps of:
S1, unloading shipments by a plurality of shipment boxes when the shipments pass through an unloading port from a delivery entrance, and outputting the shipment boxes via a delivery outlet;
S2, performing ranking, when a plurality of self-navigation trolleys enter from a sorting entrance and pass through a cyclic section, according to positions of shipments delivered by delivery device, wherein the self-navigation trolleys run out of a sorting outlet after loading the shipments at a loading port;
S3, carrying the shipments in the shipment boxes that pass through the unloading port manually or by a robot to the self-navigation trolleys that pass through the loading port;
S4, the self-navigation trolley running out of the sorting outlet and completing the sorting, without running in cycles again on the cyclic section, if an owner of the shipments on the same self-navigation trolley only owns those shipments; and
S5, the self-navigation trolley waiting to continue loading at the loading port, or, running to the cyclic section to wait to be loaded, if the owner of the shipments on the same self-navigation trolley owns other shipments, wherein when other shipments are conveyed to the unloading port, the self-navigation trolley runs to the loading port to be loaded again, and so on; finally, the self-navigation trolley runs out of the sorting outlet and completes the sorting.

13. The multi-cycle shipment sorting system according to claim 3, wherein the self-navigation trolleys are capable of passing through the loading port several times to be loaded.

14. The multi-cycle shipment sorting system according to claim 2,
wherein the identification device is a bar code, a QR code, a graphic mark, a color mark, a size mark, or an RFID tag, and correspondingly, the identifier is a camera or an RFID card reader.

15. The multi-cycle shipment sorting system according to claim 3,
wherein the identification device is a bar code, a QR code, a graphic mark, a color mark, a size mark, or an RFID tag, and correspondingly, the identifier is a camera or a RFID card reader.

16. The multi-cycle shipment sorting system according to claim 4,
wherein the identification device is a bar code, a QR code, a graphic mark, a color mark, a size mark, or an RFID tag, and correspondingly, the identifier is a camera or an RFID card reader.

17. The multi-cycle shipment sorting system according to claim 2, wherein the shipment-carrying device further comprises:
a displayer and/or a sound player, wherein the displayer and/or the sound player is electrically connected to the server, and workers load the shipments manually according to prompts of the displayer and/or the sound player.

18. The multi-cycle shipment sorting system according to claim 3, wherein the shipment-carrying device further comprises:
a displayer and/or a sound player, wherein the displayer and/or the sound player is electrically connected to the server, and workers load the shipments manually according to prompts of the displayer and/or the sound player.

19. The multi-cycle shipment sorting system according to claim 4, wherein the shipment-carrying device further comprises:
a displayer and/or a sound payer, wherein the displayer and/or the sound player is electrically connected to the server, and workers load the shipments manually according to prompts of the displayer and/or the sound player.

20. The multi-cycle shipment sorting system according to claim 5, wherein the shipment-carrying device further comprises:
a displayer and/or a sound player, wherein the displayer and/or the sound player is electrically connected to the server, and workers load the shipments manually according to prompts of the displayer and/or the sound player.
